(19) United States
(12) Patent Application Publication
(10) Pub. No.: US 2011/0224985 A1
(43) Pub. Date: Sep. 15, 2011

(54) MODEL ADAPTATION DEVICE, METHOD THEREOF, AND PROGRAM THEREOF

(76) Inventors: Ken Hanazawa, Tokyo (JP); Yoshifumi Onishi, Tokyo (JP)

(21) Appl. No.: 12/998,469

(22) PCT Filed: Oct. 23, 2009
(86) PCT No.: PCT/JP2009/068263

§ 371 Date: Apr. 25, 2011

(30) Foreign Application Priority Data
Oct. 31, 2008 (JP) 2008-281387

(51) Int. Cl. G10L 15/06

(52) U.S. Cl. 704/244; 704/E15.009

(57) ABSTRACT

A model adaptation device includes a text database that stores a plurality of sentences containing predetermined phonemes; a sentence list that includes a plurality of sentences that describe the contents of the input voice; an input unit to which the input voice is input; a model adaptation unit that performs the model adaptation using the input voice and the sentence list and outputs adapting characteristic information, which is for making the model approximate to the input voice; a statistic database that stores the adapting characteristic information; a distance calculation unit that outputs a value of an acoustic distance between the adapting characteristic information and the model for each phoneme; a phoneme detection unit that outputs a distance value, among the distance values, which is greater than a threshold value as a detection result; and a label generation unit that extracts from the text database a sentence containing a phoneme associated with the detection result and outputs the sentence.

### TECHNICAL FIELD

The present invention relates to a model adaptation device that adapts an acoustic model to a target person, such as a speaker, in order to increase the accuracy of recognition in voice recognition or the like, and a method and program thereof.

### BACKGROUND ART

The following model adaptation technique is known: the model adaptation technique for adapting an acoustic model in voice recognition to a speaker or the like to improve the accuracy of recognition. As for a supervised adaptation process in which adaptation is made by letting a speaker read a prepared sentence or word list out, what is disclosed for example in PTL 1 and FIG. 1 is a method of generating a to-be-prepared sentence list in a way that efficiently acquires a minimum amount of learning for each unit of phoneme that an acoustic model has.

According to the above method, what is provided is an original text database containing a sufficient amount of phonemes, an environment in the phonemes and sufficient other variations; the number of pieces of each phoneme is counted from the original text database to generate a number-of-pieces list.

Moreover, a rearranged list is generated by rearranging the phonemes of the number-of-pieces list in order of the number of pieces. All sentences containing a smallest-number-of-pieces phoneme a whose number of pieces is the smallest in the rearranged list are arranged in a smallest-number-of-pieces phoneme sentence list. A learning efficiency score of a phoneme model of a sentence list containing the smallest-number-of-pieces phoneme a whose number of pieces is the smallest in the rearranged list, as well as learning variation efficiency, is calculated to generate an efficiency calculation sentence list.

Then, sentences supplied from the efficiency calculation sentence list are rearranged in order of the learning efficiency score. If the learning efficiency scores take the same value, a rearranged sentence list is generated by rearranging sentences in order of the learning variation efficiency. Sentences are sequentially selected from the top of the rearranged sentence list until the number of pieces of the smallest-number-of-pieces phoneme a reaches a reference learning data number a, which is the number of voice data items required for each phoneme.

A selected sentence list is generated from the selected sentences. The number of pieces of a phoneme included in the selected sentence list is counted to generate an already-selected sentence phoneme number-of-piece list. As for a phoneme β whose number of pieces is the second smallest after the smallest-number-of-pieces phoneme a in the rearranged list, if the number in the already-selected sentence phoneme number-of-piece list has not reached the reference learning data number a, a less-than-reference-learning-data-number phoneme sentence list is generated so as to contain the phoneme β as well.

Moreover, what is disclosed in PTL 2 is an invention designed to carry out model adaptation more closely by performing speaker clustering for each phoneme group and creating and selecting an appropriate speaker cluster of phonemes.

What is disclosed in PTL 3 is the invention of a method and device that enables a user to search a multimedia database, which contains voices, or the like with a keyword voice.

What is disclosed in PTL 4 is an invention associated with phoneme model adaptation with phoneme model clustering.

What is disclosed in PTL 5 is the invention of a writer identification method and writer identification device able to determine that calligraphic specimens are made by the same writer even if the order of making strokes in writing characters to be registered in a dictionary is different from the stroke order of characters that are written for identification.

### CITATION LIST

### Patent Literature

{PTL 1} JP-A-2004-252167
{PTL 2} JP-A-2001-013986
{PTL 3} JP-A-2002-221984
{PTL 4} JP-A-2007-248742
{PTL 5} JP-A-2005-208729

### SUMMARY OF INVENTION

### Technical Problem

However, an efficient model adaptation device, which relies on a speaker for data required for model adaptation and presents the data, is not disclosed in the prior literature.

According to PTL 1, a reference learning data number a, which is an minimum amount of learning, needs to be provided manually in advance. Therefore, the problem is that it is difficult to make the settings thereof appropriately for each speaker. That is, the problem is that since the relationship between a to-be-adapted speaker and a model is not taken into account, an amount of learning for a specific phoneme can be excessive or not enough depending on the speaker.

According to the inventions disclosed in PTL 2 to 4, a sentence containing one or more phonemes is generated by performing such processes as searching a database. Moreover, when the distance between a phoneme and a model is calculated for each speaker, data created by grouping phonemes that are correlated with each other in terms of the distance are stored in a database. However, the problem is that to make careful model adaptation possible, an enormous amount of data needs to be accumulated for each speaker.

According to the invention disclosed in PTL 5, a dictionary for identifying each user is created by adding writing characteristics of users, who are different in penmanship, to a standard dictionary. However, according to a writer identification system in which a dictionary for each user can be created once a character is written and input, the problem is that it is difficult to perform model adaptation accurately in a voice identification process into which a user's uttered voice is input.

The present invention has been made in view of the above. The object of the present invention is to provide a model adaptation device able to carry out an efficient model adaptation, and a method and program thereof.

### Solution to Problem

To solve the above problems, a model adaptation device of the present invention is a model adaptation device that makes a model approximate to a characteristic of an input characteristic amount, which is input data, to adapt the model to the input characteristic amount, characterized by including: a model adaptation unit that performs model adaptation corresponding to each label from the input characteristic amount and a first supervised label sequence, which is the contents thereof, and outputs adapting characteristic information for the model adaptation; a distance calculation unit that calculates a model-to-model distance between the adapting characteristic information and the model for each of the labels; a detection unit that detects a label whose model-to-model distance exceeds a predetermined threshold value; and a label generation unit that generates a second supervised label sequence containing at least one or more labels detected when one or more labels are obtained as an output of the detection unit.

To solve the above problems, a model adaptation method of the present invention is a model adaptation method that makes a model approximate to a characteristic of an input characteristic amount, which is input data, to adapt the model to the input characteristic amount, characterized by including: a model adaptation step of performing model adaptation corresponding to each label from the input characteristic amount and a first supervised label sequence, which is the contents thereof, and outputting adapting characteristic information for the model adaptation; a distance calculation step of calculating a model-to-model distance between the adapting characteristic information and the model for each of the labels; a detection step of detecting a label whose model-to-model distance exceeds a predetermined threshold value; and a label generation step of generating a second supervised label sequence containing at least one or more labels detected when one or more labels are obtained as an output of the detection step.

To solve the above problems, a model adaptation program of the present invention is a model adaptation program that makes a model approximate to a characteristic of an input characteristic amount, which is input data, to adapt the model to the input characteristic amount, characterized by causing a computer to execute: a model adaptation process of performing model adaptation corresponding to each label from the input characteristic amount and a first supervised label sequence, which is the contents thereof, and outputting adapting characteristic information for the model adaptation; a distance calculation process of calculating a model-to-model distance between the adapting characteristic information and the model for each of the labels; a detection process of detecting a label whose model-to-model distance exceeds a predetermined threshold value; and a label generation process of generating a second supervised label sequence containing at least one or more labels detected when one or more labels are obtained as an output of the detection process.

### Advantageous Effects of Invention

As described above, according to the present invention, the model adaptation unit performs model adaptation and outputs adapting characteristic information. The distance calculation unit calculates the model-to-model distance between the adapting characteristic information and the model for each label. The label generation unit generates the second supervised label sequence containing a label whose model-to-model distance exceeds the threshold value. Therefore, it is possible to provide a model adaptation device able to perform model adaptation in an efficient manner, and a method and program thereof.

### BRIEF DESCRIPTION OF DRAWINGS

FIG. 1 A diagram for a sentence list generation method of the prior art.

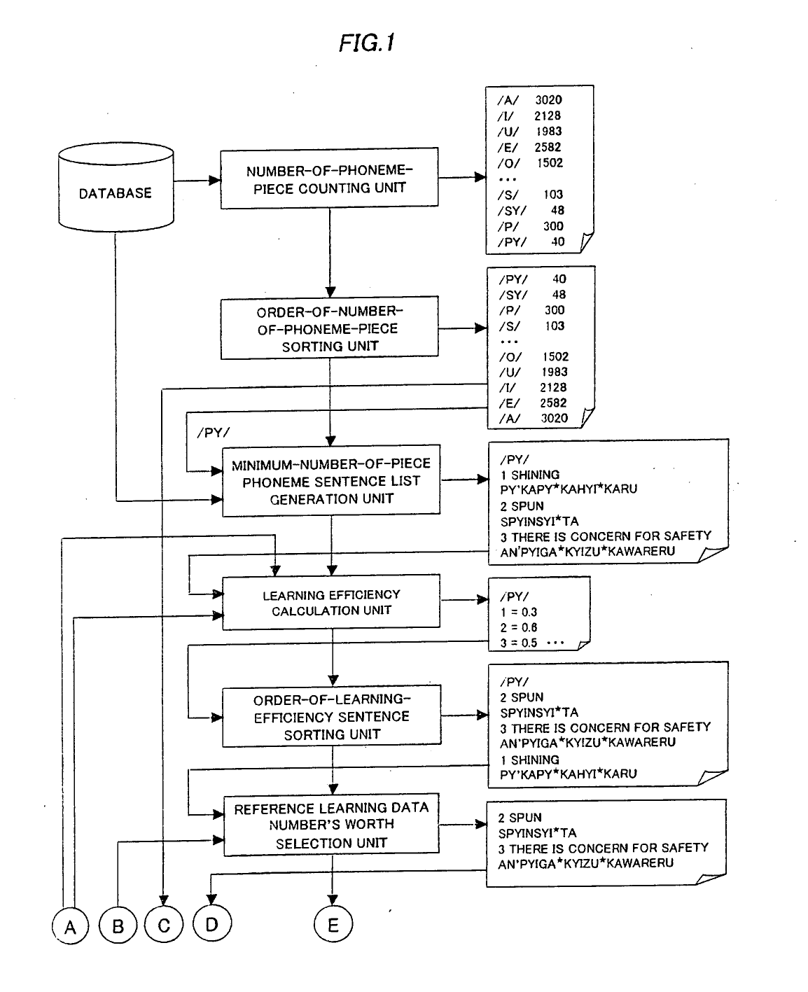

FIG. 2 A block diagram showing the configuration of a model adaptation device according to a first exemplary embodiment of the present invention.

FIG. 3 A flowchart showing a model adaptation process according to the first exemplary embodiment of the present invention.

FIG. 4 A block diagram showing the overall configuration of a speaker adaptation system according to an example of the first exemplary embodiment of the present invention.

FIG. 5 A flowchart showing a speaker adaptation process according to the example of the first exemplary embodiment of the present invention.

FIG. 6 A block diagram showing the configuration of a model adaptation device according to a second exemplary embodiment of the present invention.

FIG. 7 A block diagram showing the overall configuration of a language adaptation system according to an example of the second exemplary embodiment of the present invention.

### DESCRIPTION OF EMBODIMENTS

Hereinafter, exemplary embodiments of the present invention will be described with reference to the accompanying drawings.

### First Exemplary Embodiment

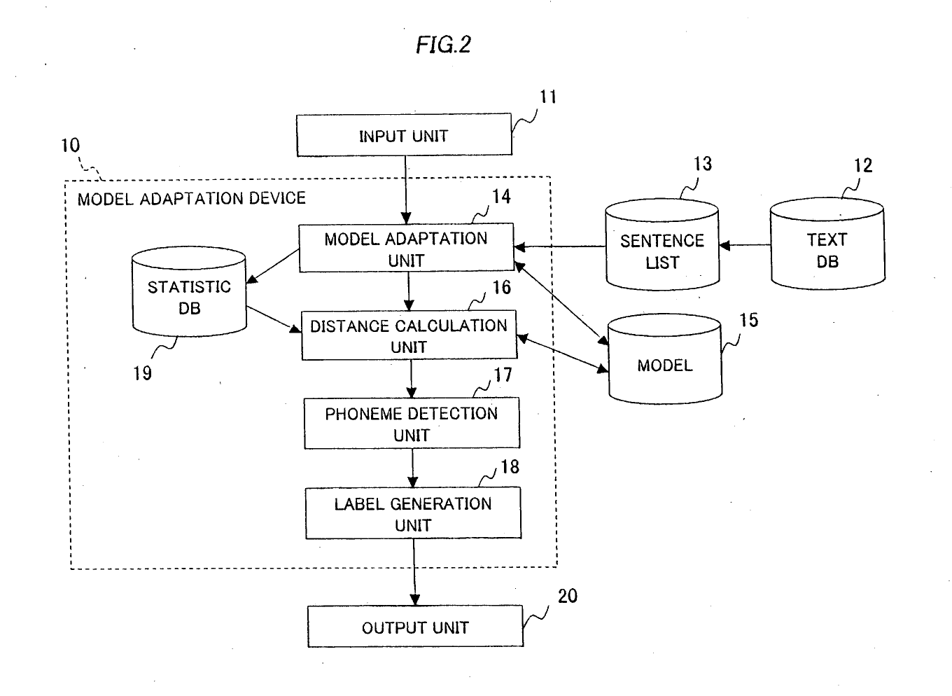

FIG. 2 is a diagram showing the overall configuration of a model adaptation device according to a first exemplary embodiment of the present invention. A model adaptation device 10 shown in FIG. 2 uses an input voice and a sentence list of uttered-voice contents to make a target acoustic model approximate to a characteristic of the input voice, thereby adapting the acoustic model to a speaker of the input voice.

The model adaptation device 10 of the present exemplary embodiment is a general-purpose computer system; the components, which are not shown in the diagram, include a CPU (Central Processing Unit), a RAM (Random Access Memory), a ROM (Read Only Memory), and a nonvolatile storage device.

In the model adaptation device 10, the CPU reads an OS (Operating System) and a model adaptation program stored in the RAM, the ROM or the nonvolatile storage device to perform a model adaptation process. Therefore, it is possible to realize adaptation so that a target model comes closer to a characteristic of the input voice. Incidentally, the model adaptation device 10 is not necessarily one computer system; the model adaptation device 10 may be made up of a plurality of computer systems.

As shown in FIG. 2, the model adaptation device 10 of the present invention includes a model adaptation unit 14, a distance calculation unit 16, a phoneme detection unit 17, a label generation unit 18, and a statistic database 19.

An input unit 11 inputs an input voice or an amount-of-characteristic sequence obtained by performing an acoustic analysis of the input voice.

A sentence list 13 is a sentence group having a plurality of sentences, in which the contents of voices that a speaker should utter, i.e. the contents of the input voices, are recorded. The sentence list 13 is selected and formed in advance from a text database 12 in which a plurality of sentences having predetermined phonemes is stored.

The predetermined phonemes in the text database 12 refer to a predetermined sufficient amount of phonemes that enables a voice to be identified.

A model 15 is for example an acoustic model used for voice identification. For example, the model 15 is a HMM (Hidden Markov Model) having a amount-of-characteristic sequence representing a characteristic of each phoneme. A technique for performing model adaptation has been widely known as a well-known technique and therefore will not be described in detail here.

The model adaptation unit 14 uses a voice, which is an input characteristic amount input by the input unit 11, and the sentence list 13, which is a first supervised label sequence and the contents of uttered voices, regards each phoneme as each label, and perform model adaptation for the phonemes so that the target model 15 approximates to the input voice. Then, adapting characteristic information is output to the statistic database 19. In this case, the adapting characteristic information is sufficient statistics required for the model 15 to approximate to the input voice.

The distance calculation unit 16 acquires the adapting characteristic information, which is output from the model adaptation unit 14, from the statistic database 19; calculates a model-to-model distance between the adapting characteristic information and the original model 15 as an acoustic distance for each phoneme; and outputs the distance value of each phoneme. In this case, for a phoneme that does not appear in the sentence list 13, the phoneme may not exist in the adapting characteristic information. In this case, the distance value can be set at 0.

If there is a distance value, among the distance values of each phoneme output from the distance calculation unit 16, which is greater than a predetermined threshold value, the phoneme detection unit 17 outputs a phoneme thereof as a detection result.

If there is one or more phonemes detected by the phoneme detection unit 17, i.e. one or more labels, the label generation unit 18 generates one or more sentences containing the detected phoneme as a second supervised label sequence in order to perform model adaptation again. In this case, in the label generation process, for example, an arbitrary sentence including the detected phoneme may be automatically generated, or, for example, a sentence containing the detected phoneme may be selected from the text database 12. If there is no phoneme detected, i.e. if the distance values of all phonemes in the phoneme detection unit 17 are less than or equal to the threshold value, no label generation takes place. That is, for example, an empty set is output as a generation result.

One or more sentences generated by the label generation unit 18 become an output of the model adaptation device 10 and are used as a new sentence list for performing model adaptation again.

Incidentally, for the text database 12, an external database, which is connected to a network, such as the Internet, may be used.

Incidentally, the text database 12, the sentence list 13, the model 15 and the statistic database 19 may be a nonvolatile storage device such as a hard disk drive, magnetic optical disk drive or flash memory, or a volatile storage device such as DRAM (Dynamic Random Access Memory). The text database 12, the sentence list 13, the model 15 and the statistic database 19 may be an external storage device attached to the model adaptation device 10.

### <Operation of First Exemplary Embodiment>

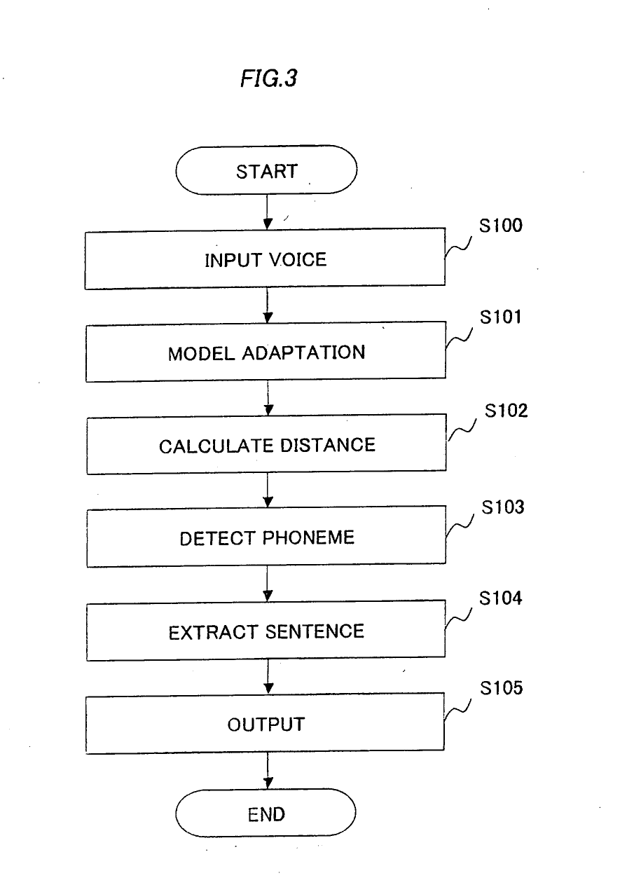

The following describes a model adaptation process of the present exemplary embodiment with reference to a flowchart shown in FIG. 3. First, the model adaptation device 10 inputs a voice (S100). More specifically, what is obtained as an input is the waveform of a voice input from a microphone or an amount-of-characteristic sequence created by performing an acoustic analysis of the voice.

Then, the model adaptation device 10 uses the input voice and the sentence list 13 of uttered-voice contents to perform adaptation so that the target model 15 approximates to the input voice (S101). More specifically, the model adaptation unit 14 of the model adaptation device 10 performs model adaptation for the model 15 based on the amount-of-characteristic sequence of the input voice obtained at step S100 and the sentence list 13 representing the contents thereof; and for example outputs sufficient statistics to the statistic database 19 as the adapting characteristic information.

For example, look at Monophone, which represents a single phoneme as a model. All that is required is for the sentence list 13 to be a supervised label in which the uttered-voice contents are described by Monophone. The model adaptation unit 14 performs supervised model adaptation; and obtains, for phoneme /s/ for example, motion vector F(s)=(s1, s2, . . . , sn) thereof and an adaptation sample number (the number of frames) as the adapting characteristic information.

A technique for model adaptation, for example, or for performing model adaptation using the amount-of-characteristic sequence as described above has been widely known as a well-known technique and therefore will not be described in detail here.

Then, the model adaptation device 10 calculates the distance between the adapting characteristic information and the model 15 (S102). That is, the model adaptation device 10 calculates the difference between the input voice and the model 15. More specifically, the distance calculation unit 16 of the model adaptation device 10 acquires from the statistic database 19 the adapting characteristic information, which is obtained at step S101 and output from the model adaptation unit 14. The distance calculation unit 16 then calculates the distance between the adapting characteristic information and the original model 15 for each phoneme and outputs the distance value of each phoneme. For example, what is obtained is a distance value for each phoneme, such as distance value Dist(s)=0.2 for phoneme /s/ and distance value Dist(a)=0.7 for phoneme /a/.

For a phoneme that does not appear in the sentence list 13, the distance value is set to 0. For example, if phoneme /z/ does not appear, Dist(z)=0.0.

A technique for calculating the distance between a vector and a model has been widely known as a well-known technique and therefore will not be described in detail here.

Then, the model adaptation device 10 detects a phoneme whose difference between the input voice and the model 15 is large (S103). More specifically, if there is a distance value, among the distance values of each phoneme output from the distance calculation unit 16 after being obtained at step S102, which is greater than a predetermined threshold value, the phoneme detection unit 17 of the model adaptation device 10 outputs a phoneme thereof as a detection result.

For example, suppose what is set is threshold value Dthre=0.5, and that as for the distance value of each phoneme, Dist(s)=0.2 for phoneme /s/ and Dist(a)=0.7 for phoneme /a/. In this case, Dthre>Dist(s), but Dthre<Dist(a). Accordingly, phoneme /a/ is detected as a phoneme that exceeds the threshold value. Needless to say, the phoneme detection target is not limited to phoneme /a/ or /s/. All phonemes in the sentence list 13 may be detected. Alternatively, the phonemes may be partly detected.

Incidentally, as for threshold value Dthre, the same value may be used for all phonemes, or a different threshold value may be used for each phoneme.

Then, the model adaptation device 10 generates a sentence to perform model adaptation again (S104). More specifically, for the phoneme associated with the detection result that is obtained at step S103 and detected by the phoneme detection unit 17, in order to generate one or more sentences containing the detected phoneme, the label generation unit 18 of the model adaptation device 10 for example searches the text database 12 for a sentence containing the detected phoneme and, at step S105, outputs the sentence extracted by the searching process. For example, when phonemes /a/ and /e/ are detected, the label generation unit 18 searches the text database 12 for one or more sentences containing phonemes /a/ and /e/, which are output if there is one or more sentences.

Incidentally, if there is no phoneme detected at step S103, the process may come to an end at step S104 without label generation, or output the fact that there is no label generation result before the process ends.

Incidentally, when model adaptation takes place again, a sufficient characteristic amount, including the adapting characteristic information obtained during the earlier model adaptation processes, is all used during the distance calculation process at step S102. Therefore, it is possible to perform an additive model adaptation process.

Incidentally, according to the present exemplary embodiment, Monophone, which represents a single phoneme as a model, is used. However, the same is true for the use of a Diphone model or Triphone model, which is dependent on a phoneme environment.

In that manner, the model adaptation device 10 of the present invention performs model adaptation for the to-be-adapted model 15 using the input voice and the first sentence list 13, detects a phoneme whose distance from the model 15 is large on the basis of a characteristic of the input voice, and generates a new sentence list containing the detected phoneme.

For example, look at the case where speakers A and B perform model adaptation. Different distance values for speakers A and B may be obtained in the following manner: in the case of speaker A, distance Dist(s)=0.2 for phoneme /s/ and distance Dist (a)=0.7 for phoneme /a/; and in the case of speaker B, distance Dist(s)=0.8 for phoneme /s/ and distance Dist (a)=0.4 for phoneme /a/. In this case, even if the same threshold value, Dthre=0.5, is used, the sentences obtained by the label generation unit 18 are different.

Similarly, even if the voice of the same speaker is used, a different sentence could be obtained when a to-be-adapted model is different. That is, even if a speaker or model is different, it is possible to perform model adaptation in an efficient manner by generating a more appropriate sentence list.

### <Example of First Exemplary Embodiment>

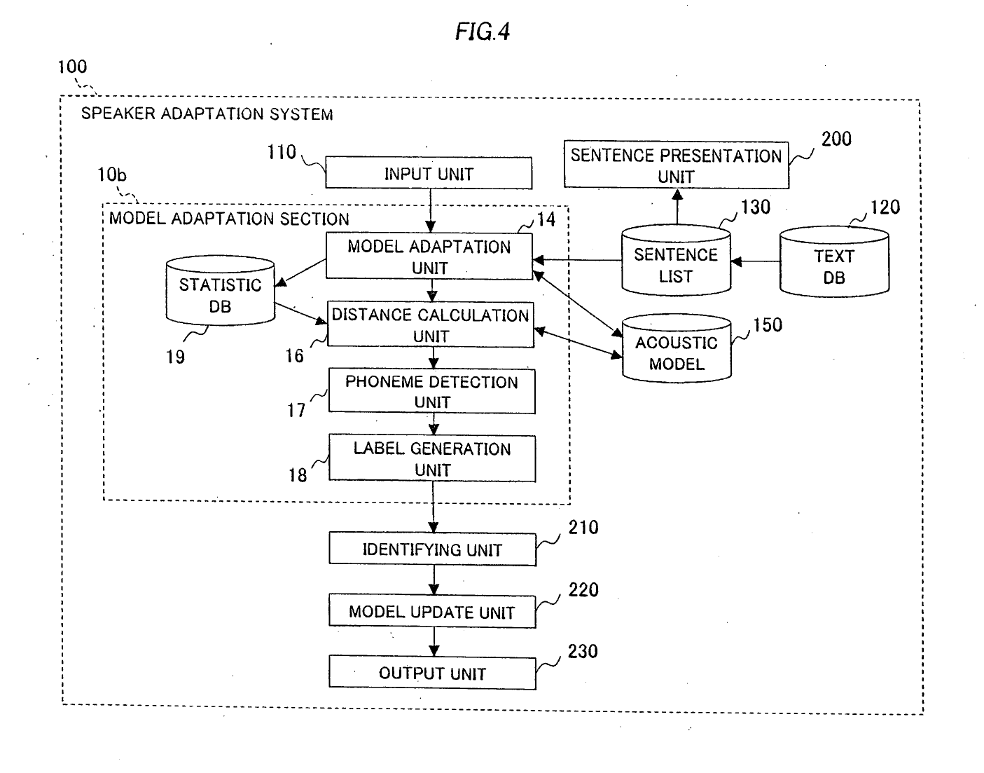

As an example of the model adaptation device of the present exemplary embodiment, the following describes an example of a speaker adaptation system. FIG. 4 is a diagram showing the overall configuration of a speaker adaptation system according to the present example. The speaker adaptation system 100 shown in FIG. 4 includes an input unit 110, a model adaptation section 10b, a text database 120, a sentence list 130, an acoustic model 150, a sentence presentation unit 200, a determination unit 210, a model update unit 220, and an output unit 230.

The speaker adaptation system 100 is a general-purpose computer system; the components, which are not shown in the diagram, include a CPU, a RAM, a ROM, and a nonvolatile storage device.

In the speaker adaptation system 100, the CPU reads an OS and a speaker adaptation program stored in the RAM, the ROM or the nonvolatile storage device to perform a speaker adaptation process. Therefore, it is possible to realize adaptation so that a target model comes closer to a characteristic of the input voice. Incidentally, the speaker adaptation system 100 is not necessarily one computer system; the speaker adaptation system 100 may be made up of a plurality of computer systems.

The input unit 110 is an input device such as a microphone. The components not shown in the diagram may include an A/D conversion unit or acoustic analysis unit.

The text database 120 is a collection of sentences containing a sufficient amount of phonemes, an environment in the phonemes and sufficient other variations.

The sentence list 130 is a supervised label used for a speaker adaptation process and a collection of sentences including one or more sentences extracted from the text database 120.

The acoustic model 150 is a HMM (Hidden Markov Model) having a amount-of-characteristic sequence representing a characteristic of each phoneme, for example.

The sentence presentation unit 200 presents a supervised label to a speaker to perform speaker adaptation. That is, the sentence presentation unit 200 presents a sentence list that the speaker should read out.

The model adaptation section 10b corresponds to the model adaptation device 10 shown in FIG. 2. Therefore, hereinafter, the differences between the model adaptation section 10b and the model adaptation device 10 shown in HG 2 will be chiefly described. The components that correspond to those shown in FIG. 2 and have the same functions will not be described.

When there is one or more phonemes detected by the phoneme detection unit 17, the label generation unit 18 generates one or more sentences containing the detected phonemes in order to perform model adaptation again and informs the determination unit 210 of the sentences. When there is no phoneme detected, the label generation unit 18 informs the determination unit 210 of the fact that there is no phoneme detected.

The determination unit 210 receives an output of the label generation unit 18.

When a sentence is generated, the determination unit 210 recognizes the sentence as a new adaptation sentence list. When no sentence is generated, the determination unit 210 informs the model update unit 220 of the fact that no sentence is generated.

When the model update unit 220 is informed by the determination unit 210 of the fact that no sentence is generated, the model update unit 220 applies the adapting characteristic information received from the statistic database 19 to the acoustic model 150 to obtain an adapted acoustic model.

Moreover, the output unit 230 outputs the adapted acoustic model, which is obtained by the model update unit 220. Incidentally, a technique for updating a model in speaker adaptation has been widely known as a well-known technique and therefore will not be described in detail here.

Incidentally, for the text database 120, an external database, which is connected to a network, such as the Internet, may be used.

The text database 120, the sentence list 130, the model 150 and the statistic database 19 may be a nonvolatile storage device such as a hard disk drive, magnetic optical disk drive or flash memory, or a volatile storage device such as DRAM. The text database 120, the sentence list 130, the model 150 and the statistic database 19 may be an external storage device attached to the speaker adaptation system 100.

### <Operation of Example of First Exemplary Embodiment>

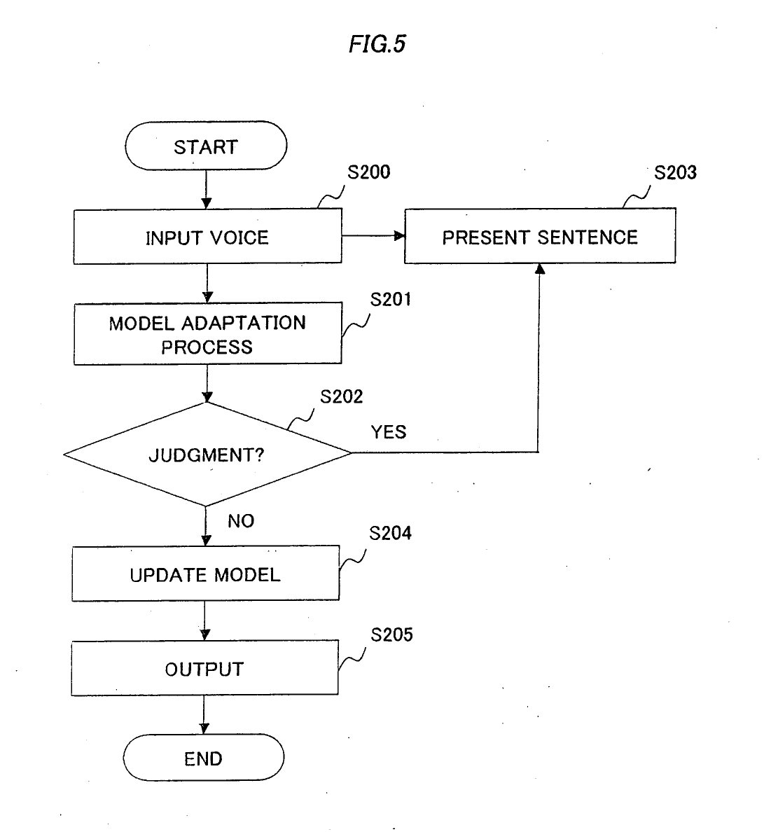

The following describes the overall flow of a speaker adaptation process according to the present example with reference to a flowchart shown in FIG. 5. First, the speaker adaptation system 100 inputs a voice (S200). More specifically, in the speaker adaptation system 100, what is obtained as an input is the waveform of a voice that is input from a microphone by the input unit 110, or an amount-of-characteristic sequence created by performing an acoustic analysis of the voice.

Then, the speaker adaptation system 100 performs a model adaptation process (S201). More specifically, what is performed is a model adaptation process as shown in FIG. 3, performed by the model adaptation unit 14, distance calculation unit 16, phoneme detection unit 17 and label generation unit 18 of the model adaptation section 10b of the speaker adaptation system 100.

The speaker adaptation system 100 then makes a determination as to whether a sentence has been output in the model adaptation process (S202). More specifically, when the determination unit 210 of the speaker adaptation system 100 outputs a sentence as a result of the model adaptation process at step S201, the output sentence is recognized as a new sentence list.

The new sentence list is presented by the speaker adaptation system 100 to a speaker again (S203). More specifically, the sentence presentation unit 200 of the speaker adaptation system 100 presents the new sentence list as a speaker adaptation supervised label to the speaker, accepts a new voice input, and repeats the process of inputting a voice at step S200 and the following processes. {0075} That is, the model adaptation unit 14 performs model adaptation again using the new sentence list and a voice input that is based on the new sentence list and outputs the , adapting characteristic information again. The statistic database 19 stores the adapting characteristic information again. The distance calculation unit 16 acquires the adapting characteristic information again from the statistic database 19; calculates the distance between the adapting characteristic information and the acoustic model for each phoneme again; and outputs the distance value of each phoneme again. If there is a distance value, among the distance values output again, that exceeds a predetermined threshold value, the phoneme detection unit 17 outputs the one exceeding the threshold value as a detection result again. The label generation unit 18 searches the text database 120 for a sentence containing a phoneme associated with the detection result that is output again and outputs a sentence extracted by the searching process.

When no sentence is output, the determination unit 210 informs the model update unit 220 of the fact that no sentence is output.

When no sentence is generated as a result of the determination process at step S202 in the speaker adaptation system 100, then a model update process is performed (S204). More specifically, with the use of the model update unit 220 of the speaker adaptation system 100, the adapting characteristic information, which is received from the statistic database 19, is applied to the acoustic model 150. Thus, an adapted acoustic model is obtained. The output unit 230 outputs the resultant adapted acoustic model as a speaker adaptation acoustic model (S205).

In that manner, in the present example, speaker adaptation takes place with a focus put on the use of a large-distance phoneme with respect to an acoustic model a speaker wants to adapt to. Therefore, it is possible to achieve an efficient speaker adaptation.

Moreover, in the present example, it is possible to stop performing the subsequent adaptation processes when the results of calculating distances for all required phonemes are less than or equal to the threshold value. That is, it is possible to stop the adaptation process when it is determined that the acoustic model has come close enough. Thus, it is possible to give a determination criterion for stopping speaker adaptation.

Incidentally, in the present example, sufficient statistics are used as the adapting characteristic information; the distance between the adapting characteristic information and the original model is calculated. However, the same is true for the case where the distance between the adapted model and the original model is calculated. In this case, all that is required is to calculate the distance between the two models; a technique for calculating the distance between the models has been widely known as a well-known technique and therefore will not be described here.

In the present example, what is described is an example of speaker adaptation in which an acoustic model is adapted to a speaker. However, the same is, for example, true for the case where an acoustic model is adapted to a difference in dialect or language. When an acoustic model is adapted to a dialect, adaptation may take place with voices of a plurality of speakers who for example speak the same Kansai dialect. When an acoustic model is adapted to a language, adaptation may take place with voices of a plurality of speakers who for example speak English with the same Japanese accent.

Moreover, in the present example, what is described is an example of supervised speaker adaptation. However, the same is true for unsupervised speaker adaptation, in which a result of recognizing a voice is directly used as a supervised label. The same is also true for the case where the distance between an input voice and an acoustic model is calculated directly.

### Second Exemplary Embodiment

Hereinafter, with reference to the accompanying drawings, a second exemplary embodiment of the present invention will be described in detail. Compared with the first exemplary embodiment, a class database is used in the present exemplary embodiment in a way that increases the efficiency of speaker adaptation even with a smaller sentence list.

In this case, the class database is a database that is built in advance with the use of a large number of voice data items. For example, the model adaptation process of the first exemplary embodiment takes place with a plurality of speakers; the results of calculating distances for each phoneme are classified to build the database.

For example, biases of classified-by-phoneme distance values, which arise from the difference between speakers, including the following, are classified: a speaker who has large distance values for both phonemes /p/ and /d/ also has a large distance value for phoneme /t/. Therefore, when the result is that the distance values for phonemes /p/ and /d/ for a given input voice are greater than or equal to the threshold value, it is possible to generate a label for phoneme /t/, which belongs to the same class, even if phoneme /t/ does not appear in the original sentence list.

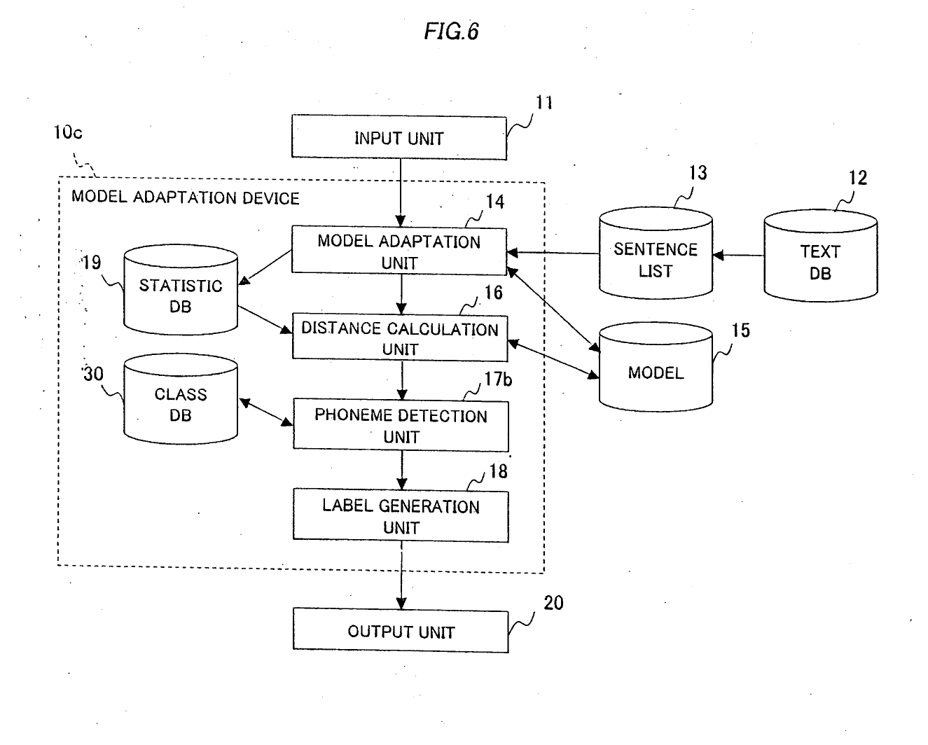

FIG. 6 is a diagram showing the overall configuration of a model adaptation device according to the second exemplary embodiment. A model adaptation device 10c shown in FIG. 6 is designed to carry out adaptation using an input voice and a sentence list of uttered-voice contents so that a target model comes closer to a characteristic of the input voice.

The model adaptation device 10c of the present invention is a general-purpose computer system; the components, which are not shown in the diagram, include a CPU, a RAM, a ROM, and a nonvolatile storage device. In the model adaptation device 10c, the CPU reads an OS and a model adaptation program stored in the RAM, the ROM or the nonvolatile storage device to perform a model adaptation process. Therefore, it is possible to realize adaptation so that a target model comes closer to a characteristic of the input voice. Incidentally, the model adaptation device 10c is not necessarily one computer system; the model adaptation device 10c may be made up of a plurality of computer systems.

As shown in FIG. 6, the model adaptation device 10c of the present invention includes a model adaptation unit 14, a distance calculation unit 16, a phoneme detection unit 17b, a label generation unit 18, a statistic database 19 and a class database 30. In this case, the model adaptation unit 14, the distance calculation unit 16, the label generation unit 18 and the statistic database 19 are the same as those in FIG. 2 and therefore will not be described. Hereinafter, only the difference from that in FIG. 2 will be described.

If there is a distance value, among the distance values of each phoneme output from the distance calculation unit 16, which is greater than a predetermined threshold value, the phoneme detection unit 17b outputs a phoneme thereof as a detection result. At the same time, the phoneme detection unit 17b looks up the class database 30 and outputs, along with the above phoneme, a phoneme belonging to the same class as a detection result among the phonemes exceeding the threshold value or combinations of phonemes.

The class database 30 is a database containing information that is generated by classifying phonemes or combinations of phonemes. For example, phonemes /p/, /b/, /t/ and /d/ belong to the same class. Therefore, for example, when two or more of the above phonemes are obtained as detection results, the remaining phonemes are also recognized as detection results: Alternatively, a rule may be described in such a way that another predetermined phoneme could also be recognized as a detection result depending on a combination of predetermined phonemes.

Incidentally, the class database 30 may be a nonvolatile storage device such as a hard disk drive, magnetic optical disk drive or flash memory, or a volatile storage device such as DRAM (Dynamic Random Access Memory). The class database 30 may be an external storage device attached to the model adaptation device 10c.

### <Operation of Second Exemplary Embodiment>

The following describes a model adaptation process according to the present exemplary embodiment. The processes of the present exemplary embodiment are the same as those shown in FIG. 3 except for the phoneme detection process at step S103 shown in FIG. 3. Therefore, the rest of the processes will not be described.

At step S103, the model adaptation device 10c detects a phoneme whose difference between the input voice and the model 15 is large. More specifically, if there is a distance value, among the distance values of each phoneme output from the distance calculation unit 16 after being obtained at step S102, which is greater than a predetermined threshold value, the phoneme detection unit 17b of the model adaptation device 10c outputs a phoneme thereof as a detection result. At the same time, the phoneme detection unit 17b looks up the class database 30 and outputs, along with the above phoneme, a phoneme belonging to the same class as a detection result among the phonemes exceeding the threshold value or combinations of phonemes. For example, if what is set is threshold value Dthre=0.6 and if, as for the distance value of each phoneme, Dist(p)=0.7 for phoneme /p/ and Dist(d)=0.9 for phoneme /d/, then phonemes /p/ and /d/ are detected as phonemes exceeding the threshold value.

At the same time, the phoneme detection unit 17b looks up the class database 30. If phonemes /p/ and /b/ belong to the same class as phonemes /t/ and /d/ in the class database 30, phonemes /t/ and /b/ are detected as well because phonemes /p/ and /d/ have been detected.

Incidentally, as for threshold value Dthre, the same value may be used for all phonemes, or a different threshold value may be used for a different phoneme. Alternatively, a different threshold value may be used for a different class, which exists in the class database 30.

In that manner, the model adaptation device 10c of the present exemplary embodiment uses the class database 30 to perform model adaptation on the to-be-adapted model 15 using the input voice and the first sentence list 13. Therefore, it becomes possible to detect a phoneme that does not exist in the sentence list 13. That is, even if the sentence list 13 is small, a suitable sentence list is generated to make it possible to perform model adaptation in an efficient manner.

### <Example of Second Exemplary Embodiment>

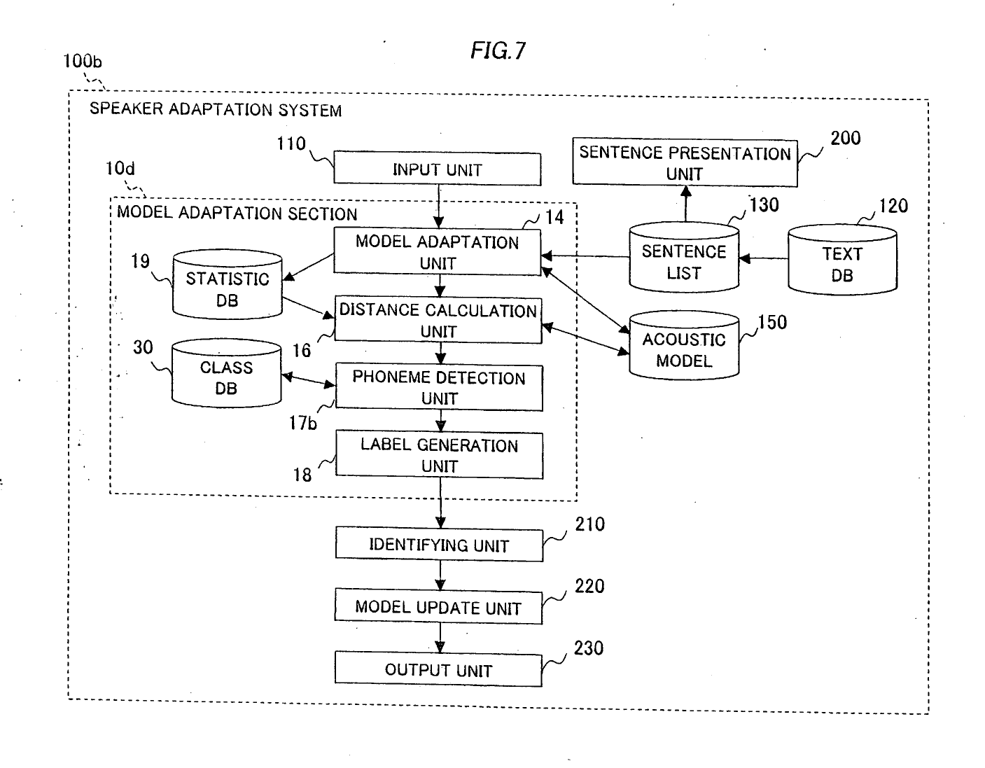

As an example of the model adaptation device of the second exemplary embodiment of the present invention, the following describes an example of a language adaptation system. FIG. 7 is a diagram showing the overall configuration of a language adaptation system according to the present example. The language adaptation system 100b shown in FIG. 7 includes an input unit 110, a model adaptation section 10d, a text database 120, a sentence list 130, an acoustic model 150, a sentence presentation unit 200, a determination unit 210, a model update unit 220, and an output unit 230.

The language adaptation system 100b is a general-purpose computer system; the components, which are not shown in the diagram, include a CPU, a RAM, a ROM, and a nonvolatile storage device. In the language adaptation system 100b, the CPU reads an OS and a language adaptation program stored in the RAM, the ROM or the nonvolatile storage device to perform a language adaptation process. Therefore, it is possible to realize adaptation so that a target model comes closer to a characteristic of the input voice. Incidentally, the language adaptation system 100b is not necessarily one computer system; the language adaptation system 100b may be made up of a plurality of computer systems.

In this case, the input unit 110, the text database 120, the sentence list 130, the acoustic model 150, the sentence presentation unit 200, the determination unit 210, the model update unit 220 and the output unit 230 are the same as those shown in FIG. 4 and therefore will not be described. The following describes only the difference from that shown in FIG. 4.

The model adaptation section 10d is a substitute for the model adaptation section 10b shown in FIG. 4, corresponding to the model adaptation device 10c shown in FIG. 6. Accordingly, the following describes chiefly the difference from that shown in FIG. 6; the components that correspond to those shown in FIG. 6 and have the same functions will not be described.

When there is one or more phonemes detected by a phoneme detection unit 17b, a label generation unit 18b generates one or more sentences containing the detected phoneme in order to perform model adaptation again and informs the determination unit 210. When there is no phoneme detected, the label generation unit 18b notifies the determination unit 210 of the fact that there is no phoneme detected.

The determination unit 210 receives an output of the label generation unit 18b. When a sentence is generated, the sentence is recognized as a new adaptation sentence list. When no sentence is generated, the determination unit 210 informs the model update unit 220 of the fact that no sentence is generated.

Incidentally, for the text database 120, an external database, which is connected to a network, such as the Internet, may be used.

The text database 120, the sentence list 130, the model 150, the statistic database 19 and the class database 30 may be a nonvolatile storage device such as a hard disk drive, magnetic optical disk drive or flash memory, or a volatile storage device such as DRAM.

The text database 120, the sentence list 130, the model 150, the statistic database 19 and the class database 30 may be an external storage device attached to the language adaptation system 100b.

### <Operation of Example of Second Exemplary Embodiment>

The following describes a language adaptation process according to the present example. In the present example, the processes of the present example are the same as those shown in FIG. 5 except for the model adaptation process at step S201 shown in FIG. 5. Therefore, the rest of the processes will not be described.

At step S102, the language adaptation system 100b performs a model adaptation process. More specifically, with the use of the model adaptation unit 14, the distance calculation unit 16, the phoneme detection unit 17b and the label generation unit 18b in the model adaptation section 10b of the language adaptation system 100b, a model adaptation process is performed as shown in FIG. 3.

In this case, suppose that in the class database 30, as data items of a Japanese speaker who is extracted from a group of a plurality of speakers and speaks the Kansai dialect, for example, phoneme /i:/ (“:” is a symbol for long vowel) belongs to the same class as phonemes /u:/ and /e:/. If the Japanese speaker who speaks the Kansai dialect performs language adaptation to an acoustic model of standard Japanese (Tokyo dialect) and the distance calculation unit 16 has detected phoneme /i:/, the phoneme detection unit 17b looks up the class database, and detects phonemes /u:/ and /e:/ belonging to the same class as well. The label generation unit 18b generates a sentence containing phonemes /i:/, /u:/ and /e:/.

In that manner, in the present example, adaptation takes place with a focus put on the use of a class of phonemes whose distance between a language a speaker wants to adapt to and a model is large, or the use of phonemes that are common among Japanese speakers who for example speak the Kansai dialect. Therefore, it is possible to achieve an efficient language adaptation even when the first sentence list is small.

Incidentally, in the present example, as an example of language adaptation in which an acoustic model is adapted to a language, an example of dialects is described. However, for example, the same is true for the case where an acoustic model is adapted to a difference between languages, i.e. between Japanese and English, or to English with a Japanese accent. Also, the same is true for the case where speaker adaptation takes place so that an acoustic model is adapted to a specific speaker in the same language or dialect.

As described above, when being used for voice recognition, the adapted acoustic model obtained by the present invention is expected to achieve a high level of recognition accuracy. Similarly, when being used for speaker verification, the adapted acoustic model is expected to achieve a high level of verification accuracy.

In recent years, it has been hoped, in some cases, that products using a voice recognition/speaker verification technique will have a high level of accuracy. The present invention can be applied to such a situation.

Incidentally, the above model adaptation device and method can be realized by hardware, software or a combination of both.

For example, the above model adaptation device can be realized by hardware. However, the model adaptation device can also be realized by a computer that reads a program, which causes the computer to function as a system thereof, from a recording medium and executes the program.

The above model adaptation method can be realized by hardware. However, the model adaptation method can also be realized by a computer that reads a program, which causes the computer to perform the method, from a computer-readable recording medium and executes the program.

Moreover, the above-described hardware and software configuration is not limited to a specific one. Any kind of configuration can be applied as long as it is possible to realize the function of each of the above-described units. For example, any of the following configurations is available: the configuration in which components are separately built for each function of each of the above units; and the configuration in which the functions of each unit are put together into one unit.

The above has described the present invention with reference to the exemplary embodiments. However, the present invention is not limited to the above exemplary embodiments. Various modifications apparent to those skilled in the art may be made on the configuration and details of the present invention without departing from the scope of the present invention.

This application is based upon and claims the benefit of priority from prior Japanese Patent Application No. 2008-281387, filed on Oct. 31, 2008, the disclosure of which is incorporated herein in its entirety by reference.

### INDUSTRIAL APPLICABILITY

The present invention can be applied to a voice input/authentication service or the like that uses a voice recognition/speaker verification technique.

### REFERENCE SIGNS LIST

10: Model adaptation device
11: Input unit
12: Text database
13: Sentence list
14: Model adaptation unit
15: Model
16: Distance calculation unit
17: Phoneme detection unit
18: Label generation unit
19: Statistic database
20: Output unit
100: Speaker adaptation system
10b: Model adaptation section
110: Input unit
120: Text database
130: Sentence list
150: Acoustic model
200: Sentence presentation unit
210: Determination unit
220: Model update unit
230: Output unit
20, 10c: Model adaptation device
17c: Phoneme detection unit
30: Class database
100b: Language adaptation system
10d: Model adaptation section

1. A model adaptation device that makes a model approximate to a characteristic of an input characteristic amount, which is input data, to adapt the model to the input characteristic amount, said device comprising:
a model adaptation unit that performs model adaptation corresponding to each label from the input characteristic amount and a first supervised label sequence, which is the contents thereof, and outputs adapting characteristic information for the model adaptation;
a distance calculation unit that calculates a model-to-model distance between the adapting characteristic information and the model for each of the labels;
a detection unit that detects a label whose model-to-model distance exceeds a predetermined threshold value; and
a label generation unit that generates a second supervised label sequence containing at least one or more labels detected when one or more labels are obtained as an output of the detection unit.

2. A model adaptation device for model adaptation that makes an acoustic model used for voice recognition approximate to a characteristic of an input voice to adapt the acoustic model to a speaker of the input voice, said device comprising:
a text database that stores a plurality of sentences containing predetermined phonemes;
a sentence list that includes a plurality of sentences that describe the contents of the input voice;
an input unit to which the input voice is input;
a model adaptation unit that performs the model adaptation using the input voice and the sentence list and outputs adapting characteristic information, which is sufficient statistics for making the acoustic model approximate to the input voice;
a statistic database that stores the adapting characteristic information;
a distance calculation unit that calculates an acoustic distance between the adapting characteristic information and the acoustic model for each phoneme and outputs a distance value for each phoneme;
a phoneme detection unit that outputs, when there is a distance value, among the distance values, which is greater than a predetermined threshold value, the distance value exceeding the threshold value as a detection result; and
a label generation unit that searches the text database for a sentence containing a phoneme associated with the detection result and outputs the sentence extracted by the searching.

3. The model adaptation device according to claim 2, further comprising:
a determination unit that recognizes, when the label generation unit outputs a sentence after the searching, the sentence as a new sentence list, while informing of the fact that the sentence is not output from the label generation unit when the sentence is not output from the label generation unit;
a model update unit that acquires the adapting characteristic information from the statistic database after being informed by the determination unit of the fact that the sentence is not output, and applies the adapting characteristic information to the acoustic model to obtain an adapted acoustic model;
an output unit that outputs the adapted acoustic model; and
a sentence presentation unit that presents the sentence list and the new sentence list, wherein:
the model adaptation unit performs model adaptation again using the new sentence list and a voice input that is based on the new sentence list, and outputs the adapting characteristic information again;
the distance calculation unit calculates a distance between the acoustic model and the adapting characteristic information output again for each phoneme, and outputs a distance value of each phoneme again;
the phoneme detection unit outputs, when there is a distance value, among the distance values output again, which is greater than the threshold value, the distance value exceeding the threshold value as a detection result again; and
the label generation unit searches the text database for a sentence containing a phoneme associated with the detection result output again and outputs the sentence extracted by the searching.

4. The model adaptation device according to claim 2, wherein
the phoneme detection unit uses a different threshold value for each phoneme.

5. The model adaptation device according to claim 2, further comprising
a class database that stores information about classified phonemes or combinations of phonemes, wherein
the phoneme detection unit looks up the class database, and also outputs, when there is a distance value, among the distance values of each phoneme output from the distance calculation unit, which is greater than the threshold value, a phoneme belonging to the same class that the phoneme exceeding the threshold value belongs to as a detection result.

6. The model adaptation device according to claim 2, wherein the input voice includes a voice and data of an amount-of-characteristic sequence obtained by performing an acoustic analysis of the voice.

7. A model adaptation method that makes a model approximate to a characteristic of an input characteristic amount, which is input data, to adapt the model to the input characteristic amount, said method comprising:
a model adaptation step of performing model adaptation corresponding to each label from the input characteristic amount and a first supervised label sequence, which is the contents thereof, and outputting adapting characteristic information for the model adaptation;
a distance calculation step of calculating a model-to-model distance between the adapting characteristic information and the model for each of the labels;
a detection step of detecting a label whose model-to-model distance exceeds a predetermined threshold value; and
a label generation step of generating a second supervised label sequence containing at least one or more labels detected when one or more labels are obtained as an output of the detection step.

8. A model adaptation method for model adaptation that makes an acoustic model used for voice recognition approximate to a characteristic of an input voice to adapt the acoustic model to a speaker of the input voice, said method comprising:
an input step of inputting the input voice;
a model adaptation step of performing the model adaptation using the input voice and a sentence list including a plurality of sentences that describe the contents of the input voice, and outputting adapting characteristic information, which is sufficient statistics for making the acoustic model approximate to the input voice;
a step of storing the adapting characteristic information in a statistic database;
a distance calculation step of calculating an acoustic distance between the adapting characteristic information and the acoustic model for each phoneme, and outputting a distance value for each phoneme;
a phoneme detection step of outputting, when there is a distance value, among the distance values, which is greater than a predetermined threshold value, the distance value exceeding the threshold value as a detection result; and
a label generation step of searching a text database, which stores a plurality of sentences containing predetermined phonemes, for a sentence containing a phoneme associated with the detection result, and outputting the sentence extracted by the searching.

9. The model adaptation method according to claim 8, further comprising:
a determination step of recognizing, when the label generation step outputs a sentence after the searching, the sentence as a new sentence list, while informing of the fact that the sentence is not output from the label generation step when the sentence is not output from the label generation step;
a model update step of acquiring the adapting characteristic information from the statistic database after being informed by the determination step of the fact that the sentence is not output, and applying the adapting characteristic information to the acoustic model to obtain an adapted acoustic model;
an output step of outputting the adapted acoustic model; and
a sentence presentation step of presenting the sentence list and the new sentence list, wherein:
the model adaptation step performs model adaptation again using the new sentence list and a voice input that is based on the new sentence list, and outputs the adapting characteristic information again;
the distance calculation step calculates a distance between the acoustic model and the adapting characteristic information output again for each phoneme, and outputs a distance value of each phoneme again;
the phoneme detection step outputs, when there is a distance value, among the distance values output again, which is greater than the threshold value, the distance value exceeding the threshold value as a detection result again; and
the label generation step searches the text database for a sentence containing a phoneme associated with the detection result output again and outputs the sentence extracted by the searching.

10. The model adaptation method according to claim 8, wherein
the phoneme detection step uses a different threshold value for each phoneme.

11. The model adaptation method according to claim 8, further comprising
a step of storing in a class database information about classified phonemes or combinations of phonemes, wherein
the phoneme detection step looks up the class database, and also outputs, when there is a distance value, among the distance values of each phoneme output from the distance calculation step, which is greater than the threshold value, a phoneme belonging to the same class that the phoneme exceeding the threshold value belongs to as a detection result.

12. The model adaptation method according to claim 8, wherein the input voice includes a voice and data of an amount-of-characteristic sequence obtained by performing an acoustic analysis of the voice.

13. A non-transitory computer-readable medium including stored therein a model adaptation program that makes a model approximate to a characteristic of an input characteristic amount, which is input data, to adapt the model to the input characteristic amount, the model adaptation program causing a computer to execute:
a model adaptation process of performing model adaptation corresponding to each label from the input characteristic amount and a first supervised label sequence, which is the contents thereof, and outputting adapting characteristic information for the model adaptation;
a distance calculation process of calculating a model-to-model distance between the adapting characteristic information and the model for each of the labels;
a detection process of detecting a label whose model-to-model distance exceeds a predetermined threshold value; and
a label generation process of generating a second supervised label sequence containing at least one or more labels detected when one or more labels are obtained as an output of the detection process.

14. A non-transitory computer-readable medium including stored therein a model adaptation program for model adaptation that makes an acoustic model used for voice recognition approximate to a characteristic of an input voice to adapt the acoustic model to a speaker of the input voice, the model adaptation program causing a computer to execute:
an input process of inputting the input voice;
a model adaptation process of performing the model adaptation using the input voice and a sentence list including a plurality of sentences that describe the contents of the input voice, and outputting adapting characteristic information, which is sufficient statistics for making the acoustic model approximate to the input voice;
a process of storing the adapting characteristic information in a statistic database;
a distance calculation process of calculating an acoustic distance between the adapting characteristic information and the acoustic model for each phoneme, and outputting a distance value for each phoneme;
a phoneme detection process of outputting, when there is a distance value, among the distance values, which is greater than a predetermined threshold value, the distance value exceeding the threshold value as a detection result; and
a label generation process of searching a text database, which stores a plurality of sentences containing predetermined phonemes, for a sentence containing a phoneme associated with the detection result, and outputting the sentence extracted by the searching.

15. The non-transitory computer-readable medium according to claim 14, wherein the model adaptation program further causes a computer to execute:
a determination process of recognizing, when the label generation process outputs a sentence after the searching, the sentence as a new sentence list, while informing of the fact that the sentence is not output from the label generation process when the sentence is not output from the label generation process;
a model update process of acquiring the adapting characteristic information from the statistic database after being informed by the determination process of the fact that the sentence is not output, and applying the adapting characteristic information to the acoustic model to obtain an adapted acoustic model;
an output process of outputting the adapted acoustic model; and
a sentence presentation process of presenting the sentence list and the new sentence list, wherein:
the model adaptation process performs model adaptation again using the new sentence list and a voice input that is based on the new sentence list, and outputs the adapting characteristic information again;
the distance calculation process calculates a distance between the acoustic model and the adapting characteristic information output again for each phoneme, and outputs a distance value of each phoneme again;
the phoneme detection process outputs, when there is a distance value, among the distance values output again, which is greater than the threshold value, the distance value exceeding the threshold value as a detection result again; and
the label generation process searches the text database for a sentence containing a phoneme associated with the detection result output again and outputs the sentence extracted by the searching.

16. The non-transitory computer-readable medium according to claim 14, wherein the phoneme detection process uses a different threshold value for each phoneme.

17. The non-transitory computer-readable medium according to claim 14, wherein the model adaptation program further causes a computer to execute
a process of storing in a class database information about classified phonemes or combinations of phonemes, wherein
the phoneme detection process looks up the class database, and also outputs, when there is a distance value, among the distance values of each phoneme output from the distance calculation process, which is greater than the threshold value, a phoneme belonging to the same class that the phoneme exceeding the threshold value belongs to as a detection result.

18. The non-transitory computer-readable medium according to claim 14, wherein the input voice includes a voice and data of an amount-of-characteristic sequence obtained by performing an acoustic analysis of the voice.
